(19) United States
(12) Patent Application Publication
(10) Pub. No.: US 2026/0205603 A1
(43) Pub. Date: Jul. 16, 2026

(54) INTRA PREDICTION METHOD AND APPARATUS, REFERENCE OBJECT DETERMINING METHOD AND APPARATUS, AND ELECTRONIC DEVICE

(71) Applicant: VIVO MOBILE COMMUNICATION CO., LTD., Dongguan (CN)

(72) Inventors: Chuan ZHOU, Dongguan (CN); Zhuoyi LV, Dongguan (CN)

(21) Appl. No.: 19/444,240

(22) Filed: Jan. 9, 2026

Related U.S. Application Data
(63) Continuation of application No. PCT/CN2024/103466, filed on Jul. 4, 2024.

(30) Foreign Application Priority Data
Jul. 11, 2023 (CN) 202310846936.5

(51) Int. Cl. H04N 19/159; H04N 19/117; H04N 19/147; H04N 19/182; H04N 19/196; H04N 19/593

(52) U.S. Cl. CPC H04N 19/159; H04N 19/117; H04N 19/147; H04N 19/182; H04N 19/196; H04N 19/593

(57) ABSTRACT

An intra prediction method and apparatus, a reference object determining method and apparatus, and an electronic device are disclosed, which pertain to the field of video encoding and decoding technologies. The intra prediction method includes: determining, by a decoder side, a target filter, and obtaining a reconstructed pixel template corresponding to the target filter; determining, by the decoder side, a coefficient of the target filter based on the reconstructed pixel template; calculating, by the decoder side, a pixel value of a sample point of a target reference object based on the coefficient of the target filter, where the target reference object is a target reference row or a target reference column; and calculating, by the decoder side, a predicted value of a current coding unit based on the pixel value of the sample point of the target reference object and an intra prediction mode of the current coding unit.

### CROSS-REFERENCE TO RELATED APPLICATIONS

This application is a continuation of International Patent Application No. PCT/CN2024/103466, filed on Jul. 4, 2024, which claims priority to Chinese Patent Application No. 202310846936.5 filed in China on Jul. 11, 2023, both of which are incorporated herein by reference in their entirety.

### TECHNICAL FIELD

This application pertains to the field of video encoding and decoding technologies, and specifically relates to an intra prediction method and apparatus, a reference object determining method and apparatus, and an electronic device.

### BACKGROUND

Video encoders use a block-based hybrid coding framework, and a coding process includes block partitioning, intra prediction, inter prediction, transform, quantization, loop filtering, and entropy coding. The encoder first divides an image into non-overlapping coding tree units (Coding Tree Unit, CTU), which are further partitioned into different coding units (Coding Unit, CU) based on a quadtree. The encoder encodes the coding units in a top-to-bottom and left-to-right sequence, and a decoder side also decodes coding units of a current frame in the same sequence. Currently, during intra-frame prediction, both an encoder side and the decoder side typically select one reference row or column from a plurality of candidate rows or columns to calculate a predicted value of a current coding unit.

### SUMMARY

Embodiments of this application provide an intra prediction method and apparatus, a reference object determining method and apparatus, and an electronic device.

According to a first aspect, an intra prediction method is provided and is performed by a decoder side, including:
determining, by the decoder side, a target filter, and obtaining a reconstructed pixel template corresponding to the target filter;
determining, by the decoder side, a coefficient of the target filter based on the reconstructed pixel template;
calculating, by the decoder side, a pixel value of a sample point of a target reference object based on the coefficient of the target filter, where the target reference object is a target reference row or a target reference column; and
calculating, by the decoder side, a predicted value of a current coding unit based on the pixel value of the sample point of the target reference object and an intra prediction mode of the current coding unit.

According to a second aspect, a reference object determining method is provided and is performed by an encoder side, including:
determining, by the encoder side based on a reconstructed pixel template, coefficients respectively corresponding to N candidate filters, where N is a positive integer;
separately calculating, by the encoder side based on the coefficients respectively corresponding to the candidate filters, pixel values of sample points of synthesized reference objects respectively corresponding to the N candidate filters, to obtain pixel values of sample points of N synthesized reference objects, where the synthesized reference object is a synthesized reference row or a synthesized reference column;
calculating, by the encoder side, N first predicted values of a current coding unit based on the pixel values of the sample points of the N synthesized reference objects, where one synthesized reference object corresponds to one first predicted value of the current coding unit; and
determining, by the encoder side, N first rate distortion costs based on the N first predicted values, and determining a target reference object based on the N first rate distortion costs, where the target reference object is one of the N synthesized reference objects.

According to a third aspect, an intra prediction apparatus is provided, including:
a first determining module, configured to: determine a target filter, and obtain a reconstructed pixel template corresponding to the target filter;
a second determining module, configured to determine a coefficient of the target filter based on the reconstructed pixel template;
a first calculation module, configured to calculate a pixel value of a sample point of a target reference object based on the coefficient of the target filter, where the target reference object is a target reference row or a target reference column; and
a second calculation module, configured to calculate a predicted value of a current coding unit based on the pixel value of the sample point of the target reference object and an intra prediction mode of the current coding unit.

According to a fourth aspect, a reference object determining apparatus is provided, including:
a third determining module, configured to determine, based on a reconstructed pixel template, coefficients respectively corresponding to N candidate filters, where N is a positive integer;
a third calculation module, configured to separately calculate, based on the coefficients respectively corresponding to the candidate filters, pixel values of sample points of synthesized reference objects respectively corresponding to the N candidate filters, to obtain pixel values of sample points of N synthesized reference objects, where the synthesized reference object is a synthesized reference row or a synthesized reference column;
a fourth calculation module, configured to calculate N first predicted values of a current coding unit based on the pixel values of the sample points of the N synthesized reference objects, where one synthesized reference object corresponds to one first predicted value of the current coding unit; and
a fourth determining module, configured to: determine N first rate distortion costs based on the N first predicted values, and determine a target reference object based on the N first rate distortion costs, where the target reference object is one of the N synthesized reference objects.

According to a fifth aspect, an electronic device is provided. The electronic device includes a processor and a memory, and the memory stores a program or instructions capable of running on the processor. When the program or the instructions are executed by the processor, the steps of the method according to the first aspect are implemented, or the steps of the method according to the second aspect are implemented.

According to a sixth aspect, a readable storage medium is provided. The readable storage medium stores a program or instructions, and when the program or the instructions are executed by a processor, the steps of the method according to the first aspect are implemented, or the steps of the method according to the second aspect are implemented.

According to a seventh aspect, a chip is provided. The chip includes a processor and a communication interface, the communication interface is coupled to the processor, and the processor is configured to run a program or instructions to implement the method according to the first aspect or the method according to the second aspect.

According to an eighth aspect, a computer program product/program product is provided. The computer program product/program product is stored in a storage medium, and the program/program product is executed by at least one processor to implement the steps of the method according to the first aspect or the steps of the method according to the second aspect.

### BRIEF DESCRIPTION OF DRAWINGS

FIG. 1A is a schematic diagram of 65 angle prediction modes included in intra prediction in VVC in a related technology;

FIG. 1B is a schematic diagram of a reference row or a reference column of a current coding unit in a related technology;

FIG. 1C is a schematic diagram of three locations of a reconstructed pixel area and a current coding unit in a related technology;

FIG. 1D is a schematic diagram of three filters of different shapes in a related technology;

FIG. 1E is a schematic diagram of calculating a current coding unit based on a filter in a related technology;

FIG. 2 is a flowchart of an intra prediction method according to an embodiment of this application;

FIG. 3 is a first schematic diagram of three candidate filters of different shapes that can be applied in an embodiment of this application;

FIG. 4 is a schematic diagram of three locations of a reconstructed pixel template and a current coding unit that can be applied in an embodiment of this application;

FIG. 5 is a flowchart of a reference object determining method according to an embodiment of this application;

FIG. 6 is a structural diagram of an intra prediction apparatus according to an embodiment of this application;

FIG. 7 is a structural diagram of a reference object determining apparatus according to an embodiment of this application;

FIG. 8 is a structural diagram of an electronic device according to an embodiment of this application; and

FIG. 9 is a structural diagram of a terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions, that is, solution 1: including A and not including B; solution 2: including B and not including A; and solution 3: including A and B. The character “/” generally indicates an “or” relationship between associated objects.

For better understanding, related concepts and technologies involved in the embodiments of this application are explained and described below.

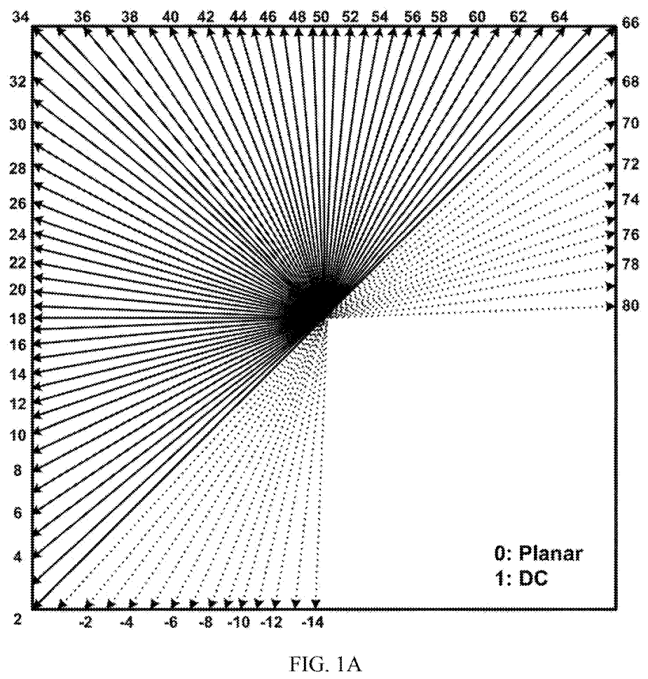

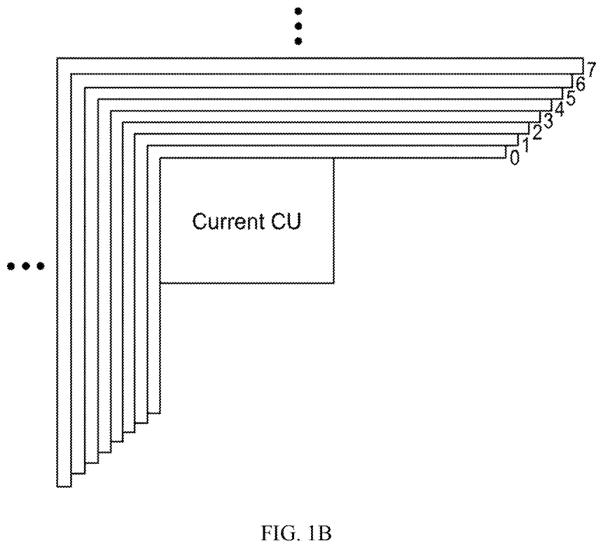

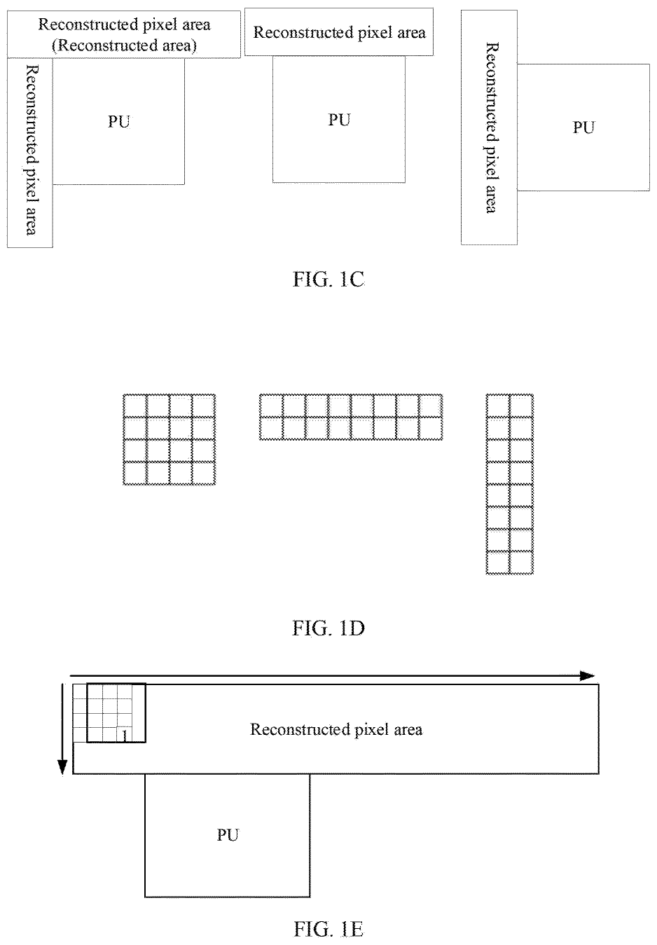

Video encoders use a block-based hybrid coding framework, and a coding process includes block partitioning, intra prediction, inter prediction, transform, quantization, loop filtering, and entropy coding. The encoder first divides an image into non-overlapping coding tree units (Coding Tree Unit, CTU), which are further partitioned into different coding units (Coding Unit, CU) based on a quadtree. The encoder then traverses a plurality of types of trees to perform partitioning, and a final partitioning result is finally determined based on a rate distortion cost. The encoder encodes the coding units in a top-to-bottom and left-to-right sequence, and a decoder side also decodes coding units of a current frame in the same sequence. The encoder uses an intra prediction technology that is based on image texture correlation, uses an upper row and a left column of reconstructed samples adjacent to a current coding unit as references. By traversing a direct current (Direct Current, DC) mode, a planar mode, and an angle prediction mode, the encoder selects an optimal intra prediction mode using a rate distortion cost, thereby removing spatial redundancy of a block. As shown in FIG. 1A, intra prediction in a latest video compression standard such as versatile video coding (Versatile Video Coding, VVC) includes 65 angle prediction modes (predModeIntra). VVC supports a plurality of reference lines. In addition to reconstructed samples in a nearest upper row and left column, a total of six reference rows with index values {1, 3, 5, 7, 12} are further included, as shown in FIG. 1B, where the index value indicates a distance between a reference row and a current coding unit.

In a related technology, implementation steps of an encoder side in “Extrapolation filter-based intra prediction mode (Extrapolation filter-based intra prediction mode, EIP)” are as follows:

Step 1: Obtain a reconstructed pixel area on an upper side or a left side of a current coding unit shown in FIG. 1C, and separately calculate 15-tap filter coefficients of three shapes shown in FIG. 1D. A calculation method follows that used in a convolutional cross-component intra model (Convolutional Cross-Component Intra Model, CCCM) in an enhanced compression model (Enhanced Compression Model, ECM) in the related technology.

### Specifically:

FIG. 1E is used as an example. Starting from an upper-left corner of a reconstructed pixel area, each 4×4 area is traversed in a top-to-bottom and left-to-right sequence for each row from a first row at the top downwards, and a weighted average is calculated by separately multiplying 15 filter coefficients with reconstructed values of gray sample points of corresponding positions in a 4×4 area. The filter coefficient is obtained by minimizing a mean-square error (mean-square error, MSE) between white samples in all 4×4 areas of the reconstructed pixel area and weighted averages calculated by using gray samples. MSE minimization is performed by calculating an autocorrelation matrix with reconstructed values of 15 gray sample points as inputs, and cross-correlation vectors between 15 gray input sample points and one white output sample point. LDL (Lower triangular matrix (Lower triangular matrix, L), diagonal matrix (Diagonal matrix, D), and transposed lower triangular matrix (transposed Lower triangular matrix, L)) decomposition is performed on the autocorrelation matrix, and a final filter coefficient is calculated through back substitution.

Step 2: Calculate a predicted value of each sample point in a left-to-right and top-to-bottom sequence starting from a first sample point in an upper left corner of the current coding unit separately by using extrapolation filters of three shapes shown in FIG. 1D, where a value of a gray sample point is an input, and a value of a white sample point in a lower right corner is an output predicted value.

A quantity of to-be-predicted sample points in the current coding unit is W×H, and W and H are respectively the width and the height of the current coding unit. A 15-tap filter (that is, a filter with 15 coefficients) is used as an example. To obtain a predicted value of a sample point in a lower right corner, 15 sample points from in an upper left part are required.

These 15 sample points may be decoded reconstructed pixels outside the current coding unit or sample points inside the current coding unit for which predicted values have been obtained, leading to several cases in FIG. 1D. 15 filter coefficients correspond one-to-one to values of the sample points.

Step 3: Calculate predicted values of the current coding unit obtained using the extrapolation filters of three shapes in an EIP mode, respectively; and then, calculate a rate distortion cost and compare the rate distortion cost with rate distortion costs of other prediction modes. If the EIP mode yields the lowest rate distortion cost, EIP mode identification information is set to 1, and is written into a bitstream together with selected filter index information.

After learning that a currently to-be-decoded coding unit is in the EIP mode, a decoder side parses an index value of a selected filter. The filter coefficient is obtained by using a decoded reconstructed pixel value on an upper side or a left side of the currently to-be-decoded coding unit in the same manner as the encoder side; a predicted value of each sample point in the current coding unit is further calculated in a top-to-bottom and left-to-right sequence; and the predicted value is added to a residual value calculated by obtaining residual information of the current coding unit from the bitstream, to obtain a reconstructed value.

In an intra prediction method in the related technology, one of a plurality of reference rows or reference columns of a current coding unit (including a total of six reference rows with index values {0, 1, 3, 5, 7, 12} shown in FIG. 1B) is usually selected as a reference sample row or reference sample column to calculate a predicted value of the current coding unit. However, a video frame may encounter a case in which texture distribution is non-uniform or noise exists. Therefore, the reference sample row or the reference sample column obtained in the foregoing manner cannot provide accurate reference information, and consequently, encoding and decoding accuracy is relatively low. For this problem, an intra prediction method and a reference object determining method are provided in the embodiments of this application.

In the embodiments of this application, when calculating a predicted value of a current coding unit, a decoder side uses a pixel value of a sample point in a target reference row or a target reference column. The pixel value of the sample point (or referred to as a pixel point) in the target reference row or the target reference column is calculated by the decoder side based on a coefficient of a target filter, that is, the target reference row or the target reference column is synthesized through calculation of the target filter, instead of calculating the predicted value by using a row or a column adjacent to the current coding unit as a reference row or a reference column. In this way, a problem can be avoided that the predicted value calculated by using the row or the column adjacent to the current coding unit as a reference row or a reference column is inaccurate when image textures are non-uniform or noise exists. In addition, because a pixel value of a sample point in a target reference object is calculated based on a reconstructed value of a plurality of rows or a plurality of columns of reconstructed pixels on an upper side and/or on a left side of the sample point, a problem in a related technology of inaccurate prediction caused when one row or one column is selected from rows or columns adjacent to the current coding unit as a reference object can be avoided. In the embodiments of this application, intra prediction is performed on the current coding unit based on a target reference row or a target reference column calculated by the target filter, which can effectively improve accuracy of intra prediction, so as to improve decoding accuracy and also help improve decoding efficiency.

With reference to the accompanying drawings, an intra prediction method, a reference object determining method, and related devices provided in the embodiments of this application are described in detail below by using specific embodiments and application scenarios thereof.

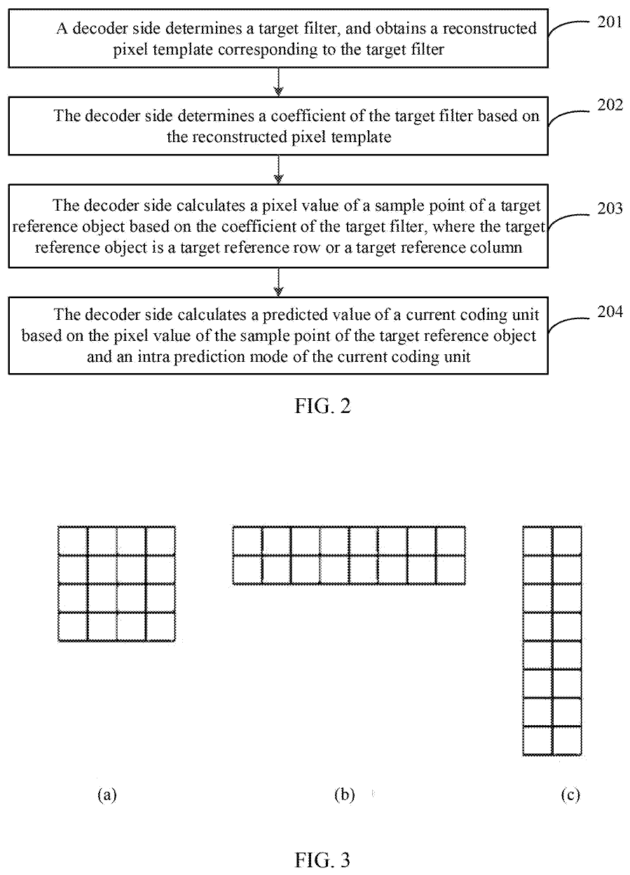

Referring to FIG. 2, FIG. 2 is a flowchart of an intra prediction method according to an embodiment of this application. The method is applied to a decoder side. As shown in FIG. 2, the intra prediction method includes the following steps.

Step 201: A decoder side determines a target filter, and obtains a reconstructed pixel template corresponding to the target filter.

Optionally, the method further includes:
obtaining, by the decoder side, intra prediction mode index information of a current coding unit from a bitstream, where the intra prediction mode index information is used to indicate an intra prediction mode of the current coding unit.

Optionally, the decoder side may obtain the intra prediction mode index information of the current coding unit from the bitstream, and the intra prediction mode index information is used to indicate an intra prediction mode used by an encoder side, and therefore, the decoder side can determine, based on the intra prediction mode index information, the intra prediction mode used by the encoder side. Therefore, based on the intra prediction mode index information, the decoder side can decode the current coding unit by using the intra prediction mode that is same as that used by the encoder side, to ensure that the decoder side can obtain a predicted value consistent with that of the encoder side. For example, the intra prediction mode involved in this embodiment of this application may be one of the 65 angle prediction modes shown in FIG. 1A.

Optionally, the decoder side may obtain filter index information from the bitstream, and determine the target filter based on the filter index information. It should be noted that one piece of filter index information is used to indicate one type of filter. For example, there may be at least one candidate filter that can be used by the encoder side and the decoder side, and each candidate filter corresponds to one piece of filter index information (also referred to as a filter identifier). The encoder side and the decoder side learn a correspondence between each candidate filter and each piece of filter index information. Further, one candidate filter is selected as the target filter at the encoder side, and the encoder side adds the filter index information corresponding to the target filter to the bitstream, and sends the bitstream to the decoder side, so that the decoder side can determine the corresponding target filter based on the filter index information. In this way, it can be ensured that the decoder side performs intra prediction by using a same filter as that used by the encoder side, so that the decoder side can obtain a predicted value consistent with that of the encoder side.

Optionally, the encoder side and the decoder side may agree to use a same filter. For example, there may be only one type of candidate filter, that is, a filter of only one shape, and the filter is the target filter. In this case, the encoder side does not need to send the filter index information to the decoder side, and the decoder side does not need to determine the target filter by using the filter index information.

In this embodiment of this application, after determining the target filter, the decoder side obtains the reconstructed pixel template corresponding to the target filter. Different candidate filters may correspond to different reconstructed pixel templates.

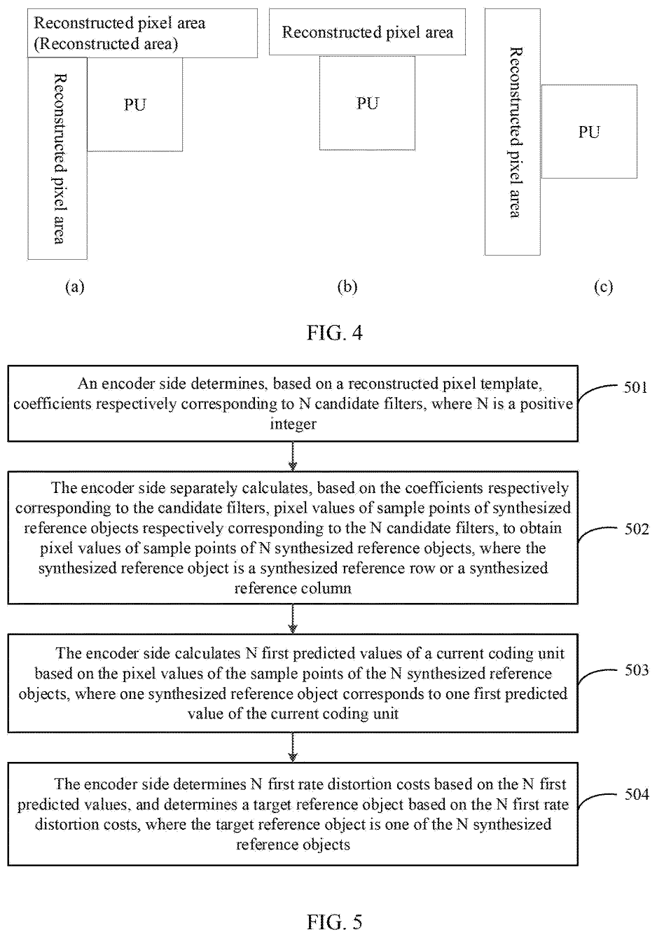

For example, three candidate filters shown in FIG. 3 are used as an example. The three candidate filters respectively correspond to three different reconstructed pixel templates. A candidate filter (a) in FIG. 3 corresponds to a reconstructed pixel template shown in (a) in FIG. 4; a candidate filter (b) in FIG. 3 corresponds to a reconstructed pixel template shown in (b) in FIG. 4; and a candidate filter (c) in FIG. 3 corresponds to a reconstructed pixel template shown in (c) in FIG. 4.

In this embodiment of this application, after determining the target filter, that is, a specific candidate filter, the decoder side can obtain a reconstructed pixel template that is corresponding to the target filter and that is composed of decoded reconstructed pixels. It should be noted that a correspondence between the candidate filter and the reconstructed pixel template may be established in advance. Forms of the candidate filter and the reconstructed pixel template shown in FIG. 3 and FIG. 4 and a correspondence between the candidate filter and the reconstructed pixel template are merely examples for description, and do not constitute a limitation on this embodiment of this application. The forms of the candidate filter and the reconstructed pixel template and the correspondence between the candidate filter and the reconstructed pixel template may alternatively be another possible case.

Step 202: The decoder side determines a coefficient of the target filter based on the reconstructed pixel template.

It should be noted that after determining the reconstructed pixel template corresponding to the target filter, the decoder side can calculate the coefficient of the target filter based on the reconstructed pixel template. A calculation method may follow a related technology, for example, calculation is performed by using a method for calculating a filter coefficient in CCCM in ECM. Details are not described in this embodiment of this application.

Step 203: The decoder side calculates a pixel value of a sample point of a target reference object based on the coefficient of the target filter, where the target reference object is a target reference row or a target reference column.

In this embodiment of this application, after determining the coefficient of the target filter, the decoder side calculates the pixel value of the sample point of the target reference row or the target reference column based on the coefficient of the target filter.

For example, it is assumed that the target filter is the filter shown in (a) in FIG. 3. The filter includes 15 sample pixel points (gray boxes in FIG. 3a) and one target pixel point (a white box in a lower right corner in FIG. 3a). The target pixel point is also a sample point of the target reference object (the target reference row or the target reference column). The pixel value that is of the target pixel and that is calculated by the decoder side based on the coefficient of the target filter is a pixel value of the sample point of the target reference object.

A quantity of coefficients of the target filter is the same as a quantity of sample pixel points in the target filter. For example, the target filter is the filter shown in (a) in FIG. 3. If the target filter includes 15 sample pixel points, the decoder side obtains 15 filter coefficients. The decoder side may separately calculate products of the 15 filter coefficients and reconstructed values of corresponding sample pixel points (the sample pixel is a decoded reconstructed pixel point around a current coding unit, and therefore, a reconstructed value of the sample pixel point is known), that is, obtain 15 products, and determine a predicted value of a target pixel point in the current coding unit based on the 15 products. For example, an average value of the products may be used as the predicted value of the target pixel point. For example, the target filter is a 15-tap filter (three types of filters shown in FIG. 3), that is, the target filter includes sample pixel points and one target pixel point for which a predicted value needs to be calculated. The predicted value of the target pixel point may be calculated by using the following formula:

$${p}_{j} = {\sum }_{i = 0}^{14} {w}_{i} \times {r}_{i}$$

where wᵢ indicates a filter coefficient corresponding to an iₜₕ reconstructed pixel point, rᵢ indicates a reconstructed value of the iₜₕ reconstructed pixel point, and pⱼ is the predicted value of the target pixel point, that is, a predicted value of a pixel point in the target reference object (such as the target reference row or the target reference column). In this way, a pixel value of the target pixel point is obtained through weighted averaging after separately multiplying reconstructed values of a plurality of rows or a plurality of columns on a left side, on an upper side, or on an upper side and a left side of the target pixel point by corresponding filter coefficients.

It should be noted that, based on the foregoing calculation manner, the decoder side obtains pixel values of target pixel points one by one in a left-to-right and top-to-bottom sequence based on the target filter. For example, the decoder side may successively calculate pixel values of pixel points in a row in a left-to-right manner, that is, the pixel points in the row are successively used as the target pixel point in the target filter (for example, a white square in a lower right corner in FIG. 3a) to calculate corresponding pixel values, so that a pixel value of each pixel point in the row is finally obtained, and the row may also be used as a target reference row for the current coding unit. Alternatively, the decoder side may successively calculate pixel values of pixel points in a column in a top-to-bottom manner, that is, the pixel points in the column are successively used as the target pixel point in the target filter to calculate corresponding pixel values, so that a pixel value of each pixel point in the column is finally obtained, and the column may also be used as a target reference column for the current coding unit. In this manner, a pixel value of each sample point (that is, a pixel point) in the target reference row or a pixel value of each sample point (that is, a pixel point) in the target reference column can be obtained. In the foregoing manner, the decoder side can also obtain pixel values of a plurality of sample points through a plurality of calculations based on the coefficient of the target filter, and combine the sample points for which pixel values have been calculated, to obtain the target reference row or the target reference column, that is, obtain the target reference object.

Step 204: The decoder side calculates a predicted value of the current coding unit based on the pixel value of the sample point of the target reference object and the intra prediction mode of the current coding unit.

Specifically, the decoder side calculates the predicted value of the current coding unit based on a calculated pixel value of the sample point in the target reference row or a calculated pixel value of the sample point in the target reference column, and the intra prediction mode of the current coding unit. It should be noted that a specific implementation process of calculating the predicted value of the current coding unit based on the reference row or the reference column and the intra prediction mode may follow the related technology. Details are not described in this embodiment.

In this embodiment of this application, in a process of calculating the predicted value of the current coding unit, the decoder side uses the pixel value of the sample point in the target reference row or the target reference column, and the pixel value of the sample point in the target reference row or the target reference column is calculated by the decoder side based on the coefficient of the target filter, that is, the target reference row or the target reference column is obtained by the decoder side through synthesis based on calculation of the target filter, and is no longer by using a row or a column adjacent to the current coding unit as a reference row to calculate the predicted value. This can avoid a problem that a predicted value calculated by using a row or a column adjacent to the current coding unit as a reference row or a reference column when image texture is non-uniform or noise exists. In this embodiment of this application, intra prediction is performed on the current coding unit by using the target reference row or the target reference column calculated by using the target filter, so that accuracy of intra prediction can be effectively improved, thereby improving decoding accuracy and helping improve decoding efficiency.

In addition, because a pixel value of each sample point (pixel point) in the target reference object is calculated through weighted averaging after separately multiplying reconstructed values of a plurality of rows or a plurality of columns of reconstructed pixels on a left side, on an upper side, or on an upper side and a left side of the target reference object by corresponding filter coefficients, if the target reference object synthesized based on such sample points is used as a reference object for the current coding unit, a problem in the related technology of inaccurate prediction caused when one row or one column is selected from rows or columns adjacent to the current coding unit as a reference object. The solution provided in this embodiment of this application can effectively improve accuracy of intra prediction.

Optionally, the determining, by a decoder side, a target filter includes:
determining, by the decoder side, the target filter when determining that the current coding unit uses the target reference object.

In this embodiment of this application, the target reference object (that is, the target reference row or the target reference column) needs to be synthesized based on a pixel value calculated based on the coefficient of the target filter. Further, if the decoder side determines that the current coding unit needs to use the synthesized target reference row or the target reference column to perform intra prediction, the target filter that needs to be selected is determined.

It should be noted that for a manner of determining the target filter, reference may be made to the foregoing description.

Optionally, before the determining, by the decoder side, the target filter when determining that the current coding unit uses the target reference object, the method further includes:
obtaining, by the decoder side, first indication information corresponding to the current coding unit from a bitstream, where the first indication information is used to indicate whether a reference object corresponding to the current coding unit is the target reference object.

Optionally, each coding unit in the bitstream corresponds to one piece of first indication information, or a plurality of coding units in the bitstream correspond to one piece of first indication information.

It may be understood that, to ensure that a predicted value consistent with that of the encoder side can be obtained, the decoder side needs to use a same intra prediction manner as that of the encoder side and select a same reference row or reference column to perform intra prediction.

In implementation of this application, the encoder side adds the first indication information to the bitstream sent to the decoder side, and the first indication information is used to indicate whether a reference object (a reference row or a reference column) used by the encoder side for the current coding unit is the target reference object (the target reference row or the target reference column). For example, if the first indication information indicates that the encoder side performs intra prediction by using the target reference object, the decoder side also needs to use the target reference object to perform intra prediction on the current coding unit; if the first indication information indicates that the encoder side does not use the target reference object to perform intra prediction, the decoder side may use a method in the related technology to select a row or a column adjacent to the current coding unit as a reference row or a reference column to perform intra prediction. Further, by using the first indication information, the decoder side can perform intra prediction by using a same reference row as the encoder side, so as to ensure that the decoder side obtains a predicted value consistent with that of the encoder side.

Optionally, the determining, by a decoder side, a target filter includes:
obtaining, by the decoder side, filter index information of the current coding unit from the bitstream; and
determining, by the decoder side, a filter corresponding to the filter index information in N candidate filters as the target filter, where N is a positive integer.

It should be noted that there may be a plurality of candidate filters that can be used by the encoder side and the decoder side, that is, candidate filters of different shapes may be used for intra prediction, for example, three candidate filters shown in FIG. 3.

Optionally, when there are a plurality of candidate filters, each candidate filter includes corresponding filter index information, and the encoder side and the decoder side learn a correspondence between each candidate filter and each piece of filter index information. The encoder side may select one of the plurality of candidate filters as the target filter to perform intra prediction, and calculate a pixel value of each sample point of the target reference object based on the coefficient of the target filter, so as to obtain a synthesized target reference object.

In this case, the encoder side adds the filter index information corresponding to the target filter to the bitstream and sends the bitstream to the decoder side, so that the decoder side can determine, based on the filter index information in the bitstream, a filter in the candidate filters that is corresponding to the filter index information as the target filter. In this way, it can be ensured that the decoder side performs intra prediction by using a same filter as that used by the encoder side, so that the decoder side can obtain a predicted value consistent with that of the encoder side.

Optionally, the candidate filter includes a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

For example, the candidate filter shown in (a) in FIG. 3 is used as an example. The candidate filter includes 15 sample pixel points (that is, gray boxes in FIG. 3(a)), and the target pixel point is a white box in a lower right corner in FIG. 3(a). The target pixel point is a sample point of the target reference object (the target reference row or the target reference column), and a pixel value of the target pixel point that is calculated by the decoder side based on a coefficient of the candidate filter is a pixel value of a sample point used as the target reference object. For a specific calculation manner and a manner of obtaining the target reference object, reference may be made to the foregoing description.

According to the intra prediction method provided in this embodiment of this application, intra prediction can be performed on the current coding unit based on the target reference row or the target reference column that is calculated based on the target filter, so that accuracy of intra prediction can be effectively improved, thereby improving decoding accuracy and helping improve decoding efficiency.

Referring to FIG. 5, FIG. 5 is a flowchart of a reference object determining method according to an embodiment of this application. The method is applied to an encoder side. As shown in FIG. 5, the reference object determining method includes the following steps.

Step 501: An encoder side determines, based on a reconstructed pixel template, coefficients respectively corresponding to N candidate filters, where N is a positive integer.

It should be noted that before this step, the encoder side first needs to determine an intra prediction mode of a current coding unit. For example, when it is determined that the intra prediction mode of the current coding unit is one of the 65 angle prediction modes shown in FIG. 1A, the encoder side determines, based on the reconstructed pixel template, the coefficients respectively corresponding to the N candidate filters.

Optionally, the encoder side may construct a reconstructed pixel template of each candidate filter based on a reconstructed pixel adjacent to the current coding unit. It should be noted that different candidate filters may correspond to different reconstructed pixel templates. Referring to FIG. 3 and FIG. 4, a candidate filter (a) in FIG. 3 corresponds to a reconstructed pixel template shown in (a) in FIG. 4, a candidate filter (b) in FIG. 3 corresponds to a reconstructed pixel template shown in (b) in FIG. 4, and a candidate filter (c) in FIG. 3 corresponds to a reconstructed pixel template shown in (c) in FIG. 4. A correspondence between the candidate filter and the reconstructed pixel template may be pre-established. Forms of the candidate filter and the reconstructed pixel template shown in FIG. 3 and FIG. 4 and the correspondence between the candidate filter and the reconstructed pixel template are merely examples for description, and do not constitute a limitation on this embodiment of this application. The forms of the candidate filter and the reconstructed pixel template and the correspondence between the candidate filter and the reconstructed pixel template may alternatively be another possible case.

In this embodiment of this application, after determining the reconstructed pixel templates corresponding to the candidate filters, the encoder side can calculate the coefficients of the corresponding candidate filters based on the reconstructed pixel templates. A calculation method may follow a related technology, for example, calculation is performed by using a method for calculating a filter coefficient in CCCM in ECM. Details are not described in this embodiment of this application.

Step 502: The encoder side separately calculates, based on the coefficients respectively corresponding to the candidate filters, pixel values of sample points of synthesized reference objects respectively corresponding to the N candidate filters, to obtain pixel values of sample points of N synthesized reference objects, where the synthesized reference object is a synthesized reference row or a synthesized reference column.

The candidate filter includes a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

For example, it is assumed that the candidate filter is the filter shown in (a) in FIG. 3. The filter includes 15 sample pixel points (gray boxes in FIG. 3a) and one target pixel point (a white box in a lower right corner in FIG. 3a). The target pixel point is also a sample point of a synthesized reference object (a synthesized reference row or a synthesized reference column).

The pixel value that is of the target pixel point and that is calculated by the decoder side based on the coefficient of the candidate filter is a pixel value of the sample point in the synthesized reference object. In this way, the encoder side can calculate one synthesized reference object (a synthesized reference row or a synthesized reference column) based on the candidate filter. In this manner, N synthesized reference objects can also be calculated based on the N candidate filters.

Specifically, the encoder side obtains pixel values of target pixel points one by one in a left-to-right and top-to-bottom sequence based on the target filter. For example, the encoder side may successively calculate pixel values of pixel points in a row in a left-to-right manner, that is, the pixel points in the row are successively used as the target pixel point in the target filter (for example, a white square in a lower right corner in FIG. 3a) to calculate corresponding pixel values, so that a pixel value of each pixel point in the row is finally obtained, and the row may also be used as a synthesized reference row for the current coding unit. Alternatively, the encoder side may successively calculate pixel values of pixel points in a column in a top-to-bottom manner, that is, the pixel points in the column are successively used as the target pixel point in the target filter to calculate corresponding pixel values, so that a pixel value of each pixel point in the column is finally obtained, and the column may also be used as a synthesized reference column for the current coding unit. In this manner, a pixel value of each sample point (that is, a pixel point) in the synthesized reference row or a pixel value of each sample point (that is, a pixel point) in the synthesized reference column can be obtained.

It should be noted that, for specific implementation of calculating the pixel value of the target pixel point based on the coefficient of the filter, reference may be made to the descriptions in the foregoing method embodiment in FIG. 2, and details are not described in this embodiment.

Step 503: The encoder side calculates N first predicted values of a current coding unit based on the pixel values of the sample points of the N synthesized reference objects, where one synthesized reference object corresponds to one first predicted value of the current coding unit.

In this embodiment of this application, the encoder side separately performs intra prediction on the current coding unit based on the pixel value of the sample point of each synthesized reference object, to obtain the first predicted value. For example, a synthesized reference object is used as an example, and the encoder side calculates an intra-frame predicted value (that is, the first predicted value) of the current coding unit based on a pixel value of a sample point of the synthesized reference object. In this manner, one first predicted value can be calculated for one synthesized reference object, so that N first predicted values are obtained.

Step 504: The encoder side determines N first rate distortion costs based on the N first predicted values, and determines a target reference object based on the N first rate distortion costs, where the target reference object is one of the N synthesized reference objects.

For example, a first predicted value is used as an example, and a corresponding rate distortion cost (that is, the first rate distortion cost) is calculated based on the first predicted value. In this manner, a first rate distortion cost corresponding to each first predicted value can be obtained, that is, N first rate distortion costs are obtained. For a manner of calculating the rate distortion cost based on the predicted value, reference may be made to a related technology, which is not specifically described in this embodiment.

Further, the encoder side may determine the target reference object based on the N first rate distortion costs, for example, may select a first predicted value corresponding to a minimum first rate distortion cost, and determine, as the target reference object, a synthesized reference object for which the first predicted value is calculated.

It should be noted that a process in which the encoder side calculates the first predicted value is also a process of performing intra prediction on the current coding unit. After determining the target reference object, the encoder side may use the first predicted value calculated based on the target reference object as the intra-frame predicted value of the current coding unit, and obtain, based on the intra-frame predicted value, a bitstream that ultimately needs to be sent to the decoder side.

In this embodiment of this application, the encoder side separately calculates, based on the coefficients respectively corresponding to the N candidate filters, pixel values of sample points in synthesized reference objects respectively corresponding to the N candidate filters, to obtain the pixel values of the sample points in the N synthesized reference objects, calculates, based on the pixel values of the sample points in the N synthesized reference objects, the N first predicted values of the current coding unit, and determines, based on these first predicted values, respective first rate distortion costs, so as to determine the target reference object from the N synthesized reference objects. All the synthesized reference objects are calculated based on the coefficients of the candidate filters, that is, the target reference objects are also calculated based on coefficients of corresponding filters, and are no longer calculated by using rows or columns adjacent to the current coding unit as reference rows or columns. This can avoid a problem that a predicted value calculated by using a row or a column adjacent to the current coding unit as a reference row or a reference column when image texture is non-uniform or noise exists. In this embodiment of this application, intra prediction is performed on the current coding unit by using the synthesized reference row or the synthesized reference column calculated based on the coefficients of the candidate filters, so that accuracy of intra prediction can be effectively improved, thereby improving encoding accuracy and helping improve encoding efficiency.

In addition, because a pixel value of each sample point in the synthesized reference object is calculated through weighted averaging after separately multiplying reconstructed values of a plurality of rows or a plurality of columns of reconstructed pixels on a left side, on an upper side, or on an upper side and a left side of the target reference object by corresponding filter coefficients, if the synthesized reference object synthesized based on such sample points is used as a reference object for the current coding unit, a problem in the related technology of inaccurate prediction caused when one row or one column is selected from adjacent rows or columns of the current coding unit as a reference object. The solution provided in this embodiment of this application can effectively improve accuracy of intra prediction.

Optionally, the determining a target reference object based on the N first rate distortion costs includes:
obtaining, by the encoder side, a minimum first rate distortion cost in the N first rate distortion costs; and
determining, by the encoder side, the target reference object based on the minimum first rate distortion cost.

In this embodiment of this application, after calculating the first rate distortion costs respectively corresponding to the N first predicted values, the encoder side obtains the minimum first rate distortion cost, determines a first predicted value corresponding to the minimum first rate distortion cost, and determines, as the target reference object, a synthesized reference object for which the first predicted value is calculated.

It should be noted that a smaller first rate distortion cost indicates that higher accuracy of a first predicted value corresponding to the first rate distortion cost and higher accuracy of a bitstream of the current coding unit that is obtained by the encoder side based on the first predicted value. In addition, the encoder side uses, as the target reference object, the synthesized reference object for which the first predicted value is calculated, uses, as the target filter, a candidate filter for which the target reference object is synthesized, and adds filter index information corresponding to the target filter to the bitstream, so that the decoder side can determine a first predicted value corresponding to a filter that is used by the encoder side, and can ensure that the decoder side can obtain, based on the target filter, a predicted value that is consistent with that of the encoder side.

Optionally, the method further includes:
obtaining, by the encoder side, a candidate reference object of the current coding unit, where the candidate reference object is a reference row or a reference column adjacent to the current coding unit;
calculating, by the encoder side, a second predicted value of the current coding unit based on the candidate reference object; and
determining, by the encoder side, a second rate distortion cost based on the second predicted value; and
the determining, by the encoder side, the target reference object based on the minimum first rate distortion cost includes:
determining, by the encoder side, the target reference object based on the minimum first rate distortion cost when the second rate distortion cost is greater than the minimum first rate distortion cost.

It should be noted that the candidate reference row or the candidate reference column is a reference row or a reference column adjacent to the current coding unit, for example, may be a first column on a left side of the current coding unit and a first column on an upper side of the current coding unit.

In this embodiment of this application, the encoder side calculates the second predicted value of the current coding unit based on neighboring reference rows or reference columns, determines the second rate distortion cost based on the second predicted value, compares the second rate distortion cost obtained based on the neighboring reference rows or reference columns with a first rate distortion cost obtained based on a synthesized reference row or a synthesized reference column. If a minimum rate distortion cost is one of the first rate distortion costs obtained based on the synthesized reference row or the synthesized reference column, the encoder side determines the target reference object based on the minimum first rate distortion cost, that is, obtains a first predicted value corresponding to the minimum first rate distortion value, and determines, as the target reference object, the synthesized reference row or the synthesized reference column for which the first predicted value is calculated.

It should be noted that if the minimum rate distortion cost is a second rate distortion cost obtained based on a neighboring reference row or reference column, the encoder side obtains a final bitstream based on the second predicted value calculated based on the neighboring reference row or reference column. In this way, the encoder side can perform intra prediction based on different reference objects, thereby improving flexibility of intra prediction.

Optionally, the method further includes:
sending, by the encoder side, a bitstream of the current coding unit to a decoder side, where the bitstream carries first indication information, and the first indication information is used to indicate whether a reference object used by the encoder side for the current coding unit is the target reference object.

For example, if the minimum rate distortion cost is one of the first rate distortion costs obtained based on the synthesized reference row or the synthesized reference column, the encoder side determines the target reference object based on the minimum first rate distortion cost, that is, the encoder side calculates the first predicted value based on the target reference object to obtain the final bitstream. In this case, the first indication information indicates that the reference object used by the encoder side is the target reference object. If the minimum rate distortion cost is the second rate distortion cost obtained based on the neighboring reference row or reference column, the encoder side obtains the final bitstream based on the second predicted value calculated based on the neighboring reference row or reference column. In this case, the first indication information may indicate that the reference object used by the encoder side is not the target reference object, but is a reference row or reference column adjacent to the current coding unit. In this way, it can be ensured that the decoder side can use the same reference object as the encoder side to perform intra prediction, so as to ensure that the decoder side obtains a bitstream that is consistent with that of the encoder side.

The intra prediction method provided in the embodiments of this application may be performed by an intra prediction apparatus. In the embodiments of this application, that the intra prediction apparatus performs the intra prediction method is used as an example to describe the intra prediction apparatus provided in the embodiments of this application.

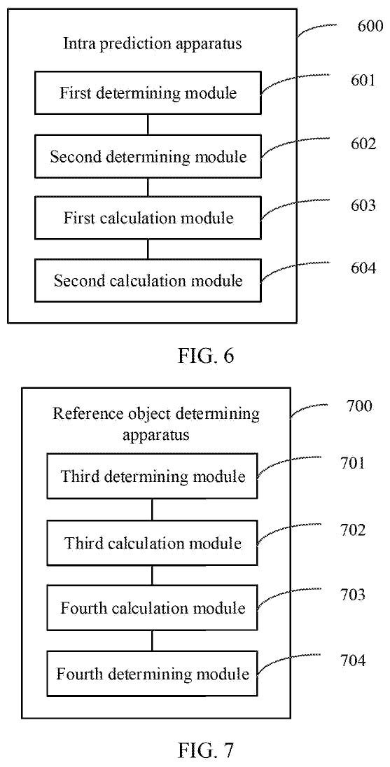

Referring to FIG. 6, FIG. 6 is a structural diagram of an intra prediction apparatus according to an embodiment of this application. The apparatus is applied to a decoder side. As shown in FIG. 6, an intra prediction apparatus 600 includes:
a first determining module 601, configured to: determine a target filter, and obtain a reconstructed pixel template corresponding to the target filter;
a second determining module 602, configured to determine a coefficient of the target filter based on the reconstructed pixel template;
a first calculation module 603, configured to calculate a pixel value of a sample point of a target reference object based on the coefficient of the target filter, where the target reference object is a target reference row or a target reference column; and
a second calculation module 604, configured to calculate a predicted value of a current coding unit based on the pixel value of the sample point of the target reference object and an intra prediction mode of the current coding unit.

Optionally, the first determining module 601 is further configured to:
determine the target filter when determining that the current coding unit uses the target reference object.

Optionally, the apparatus further includes:
a first obtaining module, configured to obtain first indication information corresponding to the current coding unit from a bitstream, where the first indication information is used to indicate whether a reference object corresponding to the current coding unit is the target reference object.

Optionally, the first determining module 601 is further configured to:
obtain filter index information of the current coding unit from the bitstream; and
determine a filter corresponding to the filter index information in N candidate filters as the target filter, where N is a positive integer.

Optionally, the candidate filter includes a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

Optionally, the apparatus further includes:
a second obtaining module, configured to obtain intra prediction mode index information of the current coding unit from the bitstream, where the intra prediction mode index information is used to indicate the intra prediction mode of the current coding unit.

According to the apparatus provided in this embodiment of this application, intra prediction can be performed on the current coding unit based on the target reference row or the target reference column that is calculated based on the target filter, so that accuracy of intra prediction can be effectively improved, thereby improving decoding accuracy and helping improve decoding efficiency.

The intra prediction apparatus 600 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The intra prediction apparatus 600 provided in this embodiment of this application can implement the processes implemented by the decoder side in the method embodiment in FIG. 2, and a same technical effect is achieved. To avoid repetition, details are not described herein again.

The reference object determining method provided in the embodiments of this application may be performed by a reference object determining apparatus. In the embodiments of this application, that the reference object determining apparatus performs the reference object determining method is used as an example to describe the reference object determining apparatus provided in the embodiments of this application.

Referring to FIG. 7, FIG. 7 is a structural diagram of a reference object determining apparatus according to an embodiment of this application. The apparatus is applied to an encoder side. As shown in FIG. 7, a reference object determining apparatus 700 includes:
a third determining module 701, configured to determine, based on a reconstructed pixel template, coefficients respectively corresponding to N candidate filters, where N is a positive integer;
a third calculation module 702, configured to separately calculate, based on coefficients respectively corresponding to the candidate filters, pixel values of sample points of synthesized reference objects respectively corresponding to the N candidate filters, to obtain pixel values of sample points of N synthesized reference objects, where the synthesized reference object is a synthesized reference row or a synthesized reference column;
a fourth calculation module 703, configured to calculate N first predicted values of a current coding unit based on the pixel values of the sample points of the N synthesized reference objects, where one synthesized reference object corresponds to one first predicted value of the current coding unit; and
a fourth determining module 704, configured to: determine N first rate distortion costs based on the N first predicted values, and determine a target reference object based on the N first rate distortion costs, where the target reference object is one of the N synthesized reference objects.

Optionally, the fourth determining module 704 is further configured to:
obtain a minimum first rate distortion cost in the N first rate distortion costs; and
determine the target reference object based on the minimum first rate distortion cost.

Optionally, the apparatus further includes:
a third obtaining module, configured to obtain a candidate reference object of the current coding unit, where the candidate reference object is a reference row or a reference column adjacent to the current coding unit;
a fifth calculation module, configured to calculate a second predicted value of the current coding unit based on the candidate reference object; and
a fifth determining module, configured to determine a second rate distortion cost based on the second predicted value; and
the fourth determining module 704 is further configured to:
determine the target reference object based on the minimum first rate distortion cost when the second rate distortion cost is greater than the minimum first rate distortion cost.

Optionally, the apparatus further includes:
a sending module, configured to send a bitstream of the current coding unit to a decoder side, where the bitstream carries first indication information, and the first indication information is used to indicate whether a reference object used by the apparatus for the current coding unit is the target reference object.

Optionally, the candidate filter includes a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

The apparatus provided in this embodiment of this application can avoid a problem that a predicted value calculated by using a row or a column adjacent to the current coding unit as a reference row or a reference column when image texture is non-uniform or noise exists. In this embodiment of this application, intra prediction is performed on the current coding unit by using the synthesized reference row or the synthesized reference column calculated based on the coefficients of the candidate filters, so that accuracy of intra prediction can be effectively improved, thereby improving encoding accuracy and helping improve encoding efficiency.

The reference object determining apparatus 700 provided in this embodiment of this application can implement the processes implemented by the encoder side in the method embodiment in FIG. 5, and a same technical effect is achieved. To avoid repetition, details are not described herein again.

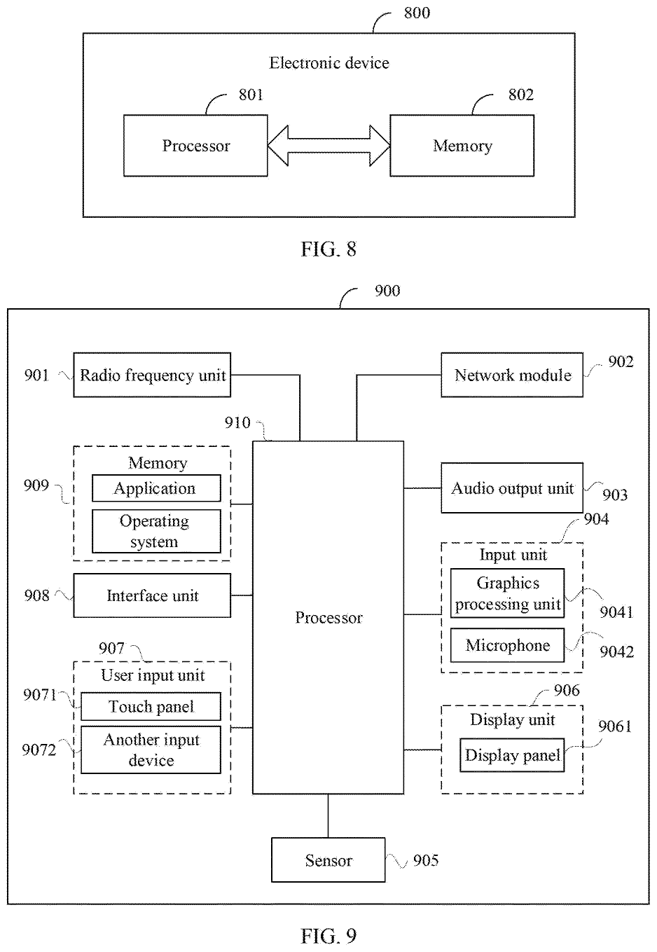

As shown in FIG. 8, an embodiment of this application further provides an electronic device 800, including a processor 801 and a memory 802, and the memory 802 stores a program or instructions capable of being run on the processor 801. For example, if the electronic device 800 is a decoder side, when the program or the instructions are executed by the processor 801, the steps of the foregoing method embodiment in FIG. 2 are implemented, and a same technical effect can be achieved. If the electronic device 800 is an encoder side, when the program or the instructions are executed by the processor 801, the steps of the method embodiment in FIG. 5 are implemented, and a same technical effect can be achieved. To avoid repetition, details are not described herein again.

An embodiment of this application further provides a terminal, which can implement the steps in the method embodiment shown in FIG. 2 or FIG. 5. Each implementation process and implementation manner of the foregoing method embodiment may be applicable to this terminal embodiment, and a same technical effect can be achieved. Specifically, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

It may be understood by a person skilled in the art that the terminal 900 may further include a power supply (such as a battery) that supplies power to each component. The power supply may be logically connected to the processor 910 by using a power management system, to implement functions such as charging, discharging, and power consumption management by using the power management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (Graphics Processing Unit, GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving data, the radio frequency unit 901 may transmit the data to the processor 910 for processing. In addition, the radio frequency unit 901 may send the data. Generally, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may include a volatile memory or a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, alternatively, the modem processor may not be integrated into the processor 910.

If the terminal 900 is a decoder side, the processor 910 is configured to:
determine a target filter, and obtain a reconstructed pixel template corresponding to the target filter;
determine a coefficient of the target filter based on the reconstructed pixel template;
calculate a pixel value of a sample point of a target reference object based on the coefficient of the target filter, where the target reference object is a target reference row or a target reference column; and
calculate a predicted value of a current coding unit based on the pixel value of the sample point of the target reference object and an intra prediction mode of the current coding unit.

If the terminal 900 is an encoder side, the processor 910 is configured to:
determine, based on a reconstructed pixel template, coefficients respectively corresponding to N candidate filters, where N is a positive integer;
separately calculate, based on coefficients respectively corresponding to the candidate filters, pixel values of sample points of synthesized reference objects respectively corresponding to the N candidate filters, to obtain pixel values of sample points of N synthesized reference objects, where the synthesized reference object is a synthesized reference row or a synthesized reference column;
calculate N first predicted values of a current coding unit based on the pixel values of the sample points of the N synthesized reference objects, where one synthesized reference object corresponds to one first predicted value of the current coding unit; and
determine N first rate distortion costs based on the N first predicted values, and determining a target reference object based on the N first rate distortion costs, where the target reference object is one of the N synthesized reference objects.

The terminal provided in this embodiment of this application can effectively improve accuracy of intra prediction.

It may be understood that, for an implementation process of the implementations mentioned in this embodiment, reference may be made to related descriptions of the method embodiment in FIG. 2 or FIG. 5, and a same or corresponding technical effect is achieved. To avoid repetition, details are not described herein again.

An embodiment of this application further provides a readable storage medium. The readable storage medium stores a program or instructions, and when the program or the instructions are executed by a processor, the processes of the foregoing embodiment of the intra prediction method or the reference object determining method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip, the chip includes a processor and a communication interface, the communication interface is coupled to the processor, and the processor is configured to run a program or instructions to implement the processes of the foregoing embodiment of the intra prediction method or the reference object determining method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a non-volatile storage medium, and the computer program/program product is executed by at least one processor to implement the processes of the foregoing embodiment of the intra prediction method or the reference object determining method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or certainly by hardware. The computer software product is stored in a storage medium (such as a ROM, a RAM, a magnetic disk, or an optical disc), and includes several instructions for instructing a terminal or a network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

1. An intra prediction method, comprising:
determining, by a decoder side, a target filter, and obtaining a reconstructed pixel template corresponding to the target filter;
determining, by the decoder side, a coefficient of the target filter based on the reconstructed pixel template;
calculating, by the decoder side, a pixel value of a sample point of a target reference object based on the coefficient of the target filter, wherein the target reference object is a target reference row or a target reference column; and
calculating, by the decoder side, a predicted value of a current coding unit based on the pixel value of the sample point of the target reference object and an intra prediction mode of the current coding unit.

2. The method according to claim 1, wherein the determining, by a decoder side, a target filter comprises:
determining, by the decoder side, the target filter when determining that the current coding unit uses the target reference object.

3. The method according to claim 2, wherein before the determining, by the decoder side, the target filter when determining that the current coding unit uses the target reference object, the method further comprises:
obtaining, by the decoder side, first indication information corresponding to the current coding unit from a bitstream, wherein the first indication information is used to indicate whether a reference object corresponding to the current coding unit is the target reference object.

4. The method according to claim 1, wherein the determining, by a decoder side, a target filter comprises:
obtaining, by the decoder side, filter index information of the current coding unit from the bitstream; and
determining, by the decoder side, a filter corresponding to the filter index information in N candidate filters as the target filter, wherein N is a positive integer.

5. The method according to claim 4, wherein the candidate filter comprises a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

6. The method according to claim 1, wherein the method further comprises:
obtaining, by the decoder side, intra prediction mode index information of the current coding unit from the bitstream, wherein the intra prediction mode index information is used to indicate the intra prediction mode of the current coding unit.

7. A reference object determining method, comprising:
determining, by an encoder side based on a reconstructed pixel template, coefficients respectively corresponding to N candidate filters, wherein N is a positive integer;
separately calculating, by the encoder side based on the coefficients respectively corresponding to the candidate filters, pixel values of sample points of synthesized reference objects respectively corresponding to the N candidate filters, to obtain pixel values of sample points of N synthesized reference objects, wherein the synthesized reference object is a synthesized reference row or a synthesized reference column;
calculating, by the encoder side, N first predicted values of a current coding unit based on the pixel values of the sample points of the N synthesized reference objects, wherein one synthesized reference object corresponds to one first predicted value of the current coding unit; and
determining, by the encoder side, N first rate distortion costs based on the N first predicted values, and determining a target reference object based on the N first rate distortion costs, wherein the target reference object is one of the N synthesized reference objects.

8. The method according to claim 7, wherein the determining a target reference object based on the N first rate distortion costs comprises:
obtaining, by the encoder side, a minimum first rate distortion cost in the N first rate distortion costs; and
determining, by the encoder side, the target reference object based on the minimum first rate distortion cost.

9. The method according to claim 8, wherein the method further comprises:
obtaining, by the encoder side, a candidate reference object of the current coding unit, wherein the candidate reference object is a reference row or a reference column adjacent to the current coding unit;
calculating, by the encoder side, a second predicted value of the current coding unit based on the candidate reference object; and
determining, by the encoder side, a second rate distortion cost based on the second predicted value; and
the determining, by the encoder side, the target reference object based on the minimum first rate distortion cost comprises:
determining, by the encoder side, the target reference object based on the minimum first rate distortion cost when the second rate distortion cost is greater than the minimum first rate distortion cost.

10. The method according to claim 7, wherein the method further comprises:
sending, by the encoder side, a bitstream of the current coding unit to a decoder side, wherein the bitstream carries first indication information, and the first indication information is used to indicate whether a reference object used by the encoder side for the current coding unit is the target reference object.

11. The method according to claim 7, wherein the candidate filter comprises a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

12. An electronic device, comprising a processor and a memory, wherein the memory stores a program or instructions capable of running on the processor, and the program or the instructions, when executed by the processor, implement an intra prediction method, comprising:
determining, by a decoder side, a target filter, and obtaining a reconstructed pixel template corresponding to the target filter;
determining, by the decoder side, a coefficient of the target filter based on the reconstructed pixel template;
calculating, by the decoder side, a pixel value of a sample point of a target reference object based on the coefficient of the target filter, wherein the target reference object is a target reference row or a target reference column; and
calculating, by the decoder side, a predicted value of a current coding unit based on the pixel value of the sample point of the target reference object and an intra prediction mode of the current coding unit.

13. The electronic device according to claim 12, wherein the determining, by a decoder side, a target filter comprises:
determining, by the decoder side, the target filter when determining that the current coding unit uses the target reference object.

14. The electronic device according to claim 13, wherein before the determining, by the decoder side, the target filter when determining that the current coding unit uses the target reference object, the method further comprises:
obtaining, by the decoder side, first indication information corresponding to the current coding unit from a bitstream, wherein the first indication information is used to indicate whether a reference object corresponding to the current coding unit is the target reference object.

15. The electronic device according to claim 12, wherein the determining, by a decoder side, a target filter comprises:
obtaining, by the decoder side, filter index information of the current coding unit from the bitstream; and
determining, by the decoder side, a filter corresponding to the filter index information in N candidate filters as the target filter, wherein N is a positive integer.

16. The electronic device according to claim 15, wherein the candidate filter comprises a sample pixel point and a target pixel point, the sample pixel point is a sample point that has been decoded or for which a pixel value has been obtained, the target pixel point is a sample point of the target reference object, and the sample pixel point is located on a left side or on an upper side of the target pixel point.

17. The electronic device according to claim 12, wherein the method further comprises:
obtaining, by the decoder side, intra prediction mode index information of the current coding unit from the bitstream, wherein the intra prediction mode index information is used to indicate the intra prediction mode of the current coding unit.

18. An electronic device, comprising a processor and a memory, wherein the memory stores a program or instructions capable of running on the processor, and when the program or the instructions are executed by the processor, the steps of the intra prediction method according to claim 7 are implemented.

19. The electronic device according to claim 18, wherein the determining a target reference object based on the N first rate distortion costs comprises:
obtaining, by the encoder side, a minimum first rate distortion cost in the N first rate distortion costs; and
determining, by the encoder side, the target reference object based on the minimum first rate distortion cost.

20. The electronic device according to claim 19, wherein the method further comprises:
obtaining, by the encoder side, a candidate reference object of the current coding unit, wherein the candidate reference object is a reference row or a reference column adjacent to the current coding unit;
calculating, by the encoder side, a second predicted value of the current coding unit based on the candidate reference object; and
determining, by the encoder side, a second rate distortion cost based on the second predicted value; and
the determining, by the encoder side, the target reference object based on the minimum first rate distortion cost comprises:
determining, by the encoder side, the target reference object based on the minimum first rate distortion cost when the second rate distortion cost is greater than the minimum first rate distortion cost.
